(19) United States
(12) Patent Application Publication
(10) Pub. No.: US 2022/0245581 A1
(43) Pub. Date: Aug. 4, 2022

(54) METHOD AND APPARATUS FOR SHARING DELIVERY BOX

(71) Applicant: Beijing Jingdong Qianshi Technology Co., Ltd., Beijing (CN)

(72) Inventors: Guangyin Lu, Beijing (CN); Yangyang Xu, Beijing (CN); Ting Sun, Beijing (CN)

(73) Assignee: Beijing Jingdong Qianshi Technology Co., Ltd., Beijing (CN)

(21) Appl. No.: 17/618,929

(22) PCT Filed: Mar. 26, 2020
(86) PCT No.: PCT/CN2020/081316

§ 371 Date: Dec. 14, 2021

(30) Foreign Application Priority Data
Jun. 28, 2019 (CN) 201910573749.8

(51) Int. Cl. G06Q 10/08

(52) U.S. Cl. CPC G06Q 10/0836

(57) ABSTRACT

A method and an apparatus for sharing a delivery box are provided. The method may include: receiving item sending-receiving information indicating delivering using a delivery box, where the item sending-receiving information includes target address information used to indicate a start fixed position of using the delivery box to carry the item; determining a matching piece from a preset set of pieces of delivery box information, where the position information and the usage status information in the matching piece meet the preset matching condition, and the matching piece includes the position information, the first identification information and the usage status information used to represent whether the delivery box indicated by the corresponding first identification information is occupied; and updating the usage status information in the matching piece to the information representing that the delivery box is occupied.

This application is a national stage of International Application No. PCT/CN2020/081316, filed on Mar. 26, 2020, which claims the priority of Chinese Patent Application No. 201910573749.8, titled “METHOD AND APPARATUS FOR SHARING DELIVERY BOX”, filed on Jun. 28, 2019. Both of the aforementioned applications are hereby incorporated by reference in their entireties.

### TECHNICAL FIELD

Embodiments of the present disclosure relate to the technical fields of computers, specifically to a method and apparatus for sharing a delivery box.

### BACKGROUND

With the development of e-commerce and Internet technology, logistics technology is becoming more and more intelligent.

In the process of delivery of items or waiting for delivery of items, if the items cannot be delivered in person, there are generally two related approaches: the first one is to place the items to be delivered in the preset logistics stations (such as self-pickup cabinets), and the second one is to place them near the delivery positions or the handover positions (for example, the items can be placed directly at the doors or received by others).

### SUMMARY

Embodiments of the present disclosure provide a method and apparatus for sharing a delivery box.

In a first aspect, the embodiments of the present disclosure provide the method for sharing a delivery box, and the method includes: receiving item sending-receiving information indicating delivering using a delivery box, where the matching piece of delivery box information includes: position information, first identification information and usage status information, the position information and the usage status information meet a preset matching condition, and the usage status information is used to represent whether the delivery box indicated by the corresponding first identification information is occupied; and updating the usage status information in the matching piece of delivery box information to information representing that the delivery box is occupied.

In a second aspect, the embodiments of the present disclosure provide the apparatus for sharing a delivery box, and the apparatus includes: a receiving unit, configured to receive item sending-receiving information indicating delivering using the delivery box, where the item sending-receiving information includes target address information, and the target address information is used to indicate a start fixed position of using the delivery box to carry the item; a first determining unit, configured to determine a matching piece of delivery box information from a preset set of pieces of delivery box information, where the matching piece of delivery box information includes: position information, first identification information and usage status information, and the position information and the usage status information meet a preset matching condition, and the usage status information is used to represent whether the delivery box indicated by the corresponding first identification information is occupied; and a first updating unit, configured to update the usage status information in the matching piece of delivery box information to information representing that the delivery box is occupied.

In a third aspect, the embodiments of the present disclosure provide a sharing system of a smart delivery box. The system includes: a server, configured to implement the method as described in any one of the implementations of the first aspect; a smart delivery box, including a communication component and a smart lock, where the smart lock is controlled to be unlocked by the communication component; and a fixed apparatus installed at a preset delivery position, configured to be detachably connected to the smart lock through a lock body.

In a fourth aspect, the embodiments of the present disclosure provide a server. The server includes one or more processors; and a storage apparatus storing one or more programs, where the one or more programs, when executed by the one or more processors, cause the one or more processors to implement the method as described in any one of the implementations of the first aspect.

In a fifth aspect, the embodiments of the present disclosure provide a computer-readable medium storing a computer program, where the program, when executed by a processor, implements the method as described in any one of the implementations of the first aspect.

### BRIEF DESCRIPTION OF THE DRAWINGS

By reading the detailed description of non-limiting embodiments with reference to the following accompanying drawings, other features, objects and advantages of the disclosure will become more apparent.

FIG. 1 is an example system architecture to which an embodiment of the present disclosure may be applied;

FIG. 2 is a flowchart of an embodiment of a method for sharing a delivery box according to the present disclosure;

FIG. 3 is a schematic diagram of an application scenario of an embodiment of the method for sharing a delivery box according to the present disclosure;

FIG. 4 is a flowchart of another embodiment of the method for sharing a delivery box according to the present disclosure;

FIG. 5 is a schematic structural diagram of an embodiment of an apparatus for sharing a delivery box according to the present disclosure;

FIG. 6 is a schematic structural diagram of an embodiment of a sharing system of an smart delivery box according to the present disclosure; and

FIG. 7 is a schematic structural diagram of an electronic device adapted to implement embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should be noted that the embodiments in the disclosure and the features in the embodiments may be combined with each other on a non-conflict basis. The disclosure will be described below in detail with reference to the accompanying drawings and in combination with the embodiments.

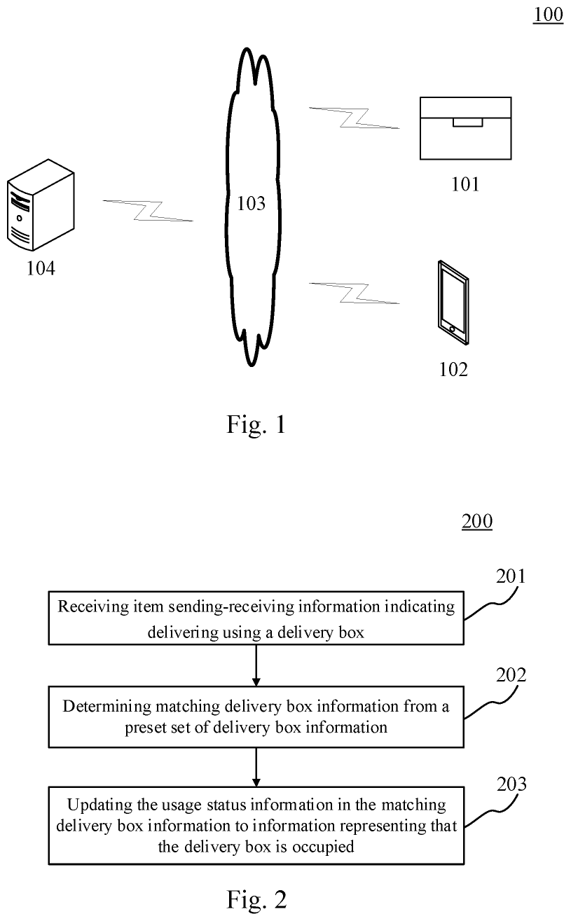

FIG. 1 shows an example system architecture 100 to which a method or apparatus for sharing a delivery box of the present disclosure may be applied.

As shown in FIG. 1, the system architecture 100 may include a delivery box 101, a terminal device 102, a network 103 and a server 104. The network 103 serves as a medium for providing a communication link between the delivery box 101, the terminal device 102 and the server 104. The network 103 may include various types of connections, such as wired or wireless communication links, or optical fiber cables.

The delivery box 101 and the terminal device 102 interact with the server 104 through the network 103 to receive or send messages. Various communication client applications, such as smart lock applications and shopping applications, may be installed on the delivery box 101 and the terminal device 102.

The delivery box 101 and the terminal device 102 may be hardware or software. When the delivery box 101 is hardware, the delivery box 101 may be a box having a communication component and a smart lock, and when the terminal device 102 is hardware, the terminal device 102 may be various electronic devices having a display screen and supporting communication, including but not limited to, a smart phone, a tablet computer, a laptop portable computer and a desktop computer; and when the delivery box 101 and the terminal device 102 are software, the delivery box 101 and the terminal device 102 may be installed in the electronic devices, and may be implemented as multiple software pieces or software modules (such as software pieces or software modules for providing distributed services), or as a single software piece or software module, which is not specifically limited herein.

The server 104 may be a server providing various services, such as a background server providing support for the terminal device 102 and unlocking of the smart lock on the delivery box 101. The background server may perform verification on information sent by the terminal device 102 to control the unlocking of the smart lock on the delivery box 101.

It should be noted that the server 104 may be hardware or software. When the server 104 is hardware, the server 104 may be implemented as a distributed server cluster composed of multiple servers, or as a single server; and when the server 104 is software, the server 104 may be implemented as multiple software pieces or software modules (such as software pieces or software modules for providing distributed services), or as a single software piece or software module, which is not specifically limited herein.

It should be noted that the method for sharing a delivery box provided by the embodiments of the present disclosure is generally executed by the server 104. Correspondingly, the apparatus for sharing a delivery box is generally provided in the server 104.

It should be appreciated that the number of the delivery box, the terminal device, the network and the server in FIG. 1 is merely illustrative. Any number of delivery boxes, terminal devices, networks and servers may be provided according to actual requirements.

Further referring to FIG. 2, FIG. 2 shows a flow 200 of an embodiment of a method for sharing a delivery box according to the present disclosure. The method for sharing a delivery box includes steps 201 to 203.

Step 201 includes receiving item sending-receiving information indicating delivering using a delivery box.

In this embodiment, the execution body of the method for sharing a delivery box (such as the server 104 shown in FIG. 1) may receive the item sending-receiving information indicating delivering using the delivery box through a wired connection or a wireless connection. The item sending-receiving information may be used to indicate a logistics status of the item. The item sending-receiving information may include target address information. The target address information may be used to indicate a start fixed position at which the delivery box is used to carry the item. The start fixed position may be an address of a fixed apparatus connected to the delivery box. As an example, in the case of sending an item, the target address information may be an address of a fixed apparatus connected to a delivery box carrying an item to be sent. As another example, in the case of receiving an item, the target address information may be an address of a fixed apparatus connected to a delivery box carrying an item to be received. Alternatively, a start position of using the delivery box to carry the item may be at a courier before the delivery box is connected to the fixed apparatus.

In this embodiment, the execution body may receive the item sending-receiving information indicating delivering using the delivery box from various electronic devices. As an example, the execution body may receive item sending-receiving information indicating delivering using a delivery box and being sent by a terminal device used by a user. As another example, the execution body may alternatively receive item sending-receiving information indicating delivering using a delivery box and being sent by a background server providing support for an e-commerce. The background server providing support for the e-commerce, may extract the item sending-receiving information from order information.

Step 202 includes determining a matching piece of delivery box information from a preset set of pieces of delivery box information.

In this embodiment, the execution body may determine the matching piece of delivery box information from the preset set of pieces of delivery box information using various methods. Position information and usage status information in the matching piece of delivery box information may meet a preset matching condition. The preset set of pieces of delivery box information may be pre-stored in the execution body locally. The pieces of delivery box information in the preset set of pieces of delivery box information may be updated based on actual statuses of delivery boxes. The pieces of delivery box information may include the position information, first identification information, and the usage status information. The first identification information may be used to distinguish different pieces of delivery box information in the preset set of pieces of delivery box information. The first identification information may correspond one-to-one to a delivery box indicated by the piece of delivery box information. The first identification information may be in various forms, such as a letter, a number or a Chinese character. As an example, the first identification information may be an ID (identity, identity number) of the delivery box, such as 110021 or 100016.

The position information may be used to indicate a position where the delivery box is located. The position information may be in various forms, such as a letter, a number or a Chinese character. As an example, the position information may be a longitude and latitude of a position where the delivery box is located, or may be an address of the position where the delivery box is located. Alternatively, the position information may further be represented by a specific terminal or a specific address. The specific terminal may be, for example, a terminal used by a courier. The specific address may be, for example, a warehousing address of the delivery box. The specific address may alternatively be, for example, an address of a fixed apparatus connected to the delivery box. The fixed apparatus may be installed at each of preset delivery positions. The fixed apparatus may be detachably connected to the delivery box. Thus, the position information may be used to represent that the delivery box is located at a courier indicated by the specific terminal, at the specific warehousing address, or at the fixed apparatus.

The usage status information may be used to represent whether the delivery box indicated by the corresponding first identification information is occupied. The usage status information may include information representing whether the delivery box is occupied. The information representing that the delivery box is occupied may include, but is not limited to, at least one of the following: information representing that an item is to be collected, or information representing that the delivery box is reserved and occupied. Here, the information representing that the item is to be collected may be used to indicate that a delivery box is in an “item-to-be-collected” usage status, which may be applied to a scenario in which a courier puts an item to be collected into a delivery box or a user puts an item to be sent into a delivery box. The information representing the delivery box is reserved and occupied may be used to indicate that a delivery box is in a “reserved and occupied” usage status, which may be applied to a scenario in which a user needs to use the delivery box in a certain time period in the future. The information representing that the delivery box is not occupied may include, but is not limited to, at least one of the following: information indicating idleness, information representing that a usage is completed, or information representing that a delivery box is to be recycled. Here, the information representing the idleness may be used to indicate that a delivery box is in an “idle” usage status, which may be applied to a scenario in which an empty delivery box is located at the specific address. The information representing that the usage is completed may be used to indicate that the delivery box is in a “usage completed” usage status, which may be applied to a scenario in which an empty delivery box is located at the courier indicated by the specific terminal. The information representing that the delivery box is to be recycled may be used to indicate that the delivery box is in a “to-be-recycled” usage status, which may be applied to a scenario in which a courier is instructed to detach a delivery box connected to a fixed apparatus from the fixed apparatus.

The position information may be used to indicate a position where the delivery box is located. The position information may be represented in various forms, such as a letter, a number or a Chinese character. As an example, the position information may be a longitude and latitude of a position where the delivery box is located, or may be an address of the position where the delivery box is located. Alternatively, the position information may further be represented by a specific terminal or a specific address. The specific terminal may be, for example, a terminal used by a courier. The specific address may be, for example, a warehousing address of the delivery box. The specific address may alternatively be, for example, an address of a fixed apparatus connected to the delivery box. The fixed apparatus may be installed at preset delivery positions. The fixed apparatus may be detachably connected to the delivery box. Thus, the position information may be used to represent that the delivery box is located at a courier indicated by the specific terminal, at the specific warehousing address, or at the fixed apparatus.

In this embodiment, the preset matching condition may include a position matching condition and a usage status matching condition. As an example, the position matching condition may include that a distance between a position indicated by target address information and a position indicated by position information in delivery box information is smaller than a preset distance. As another example, the position matching condition may include position information in delivery box information indicating that a delivery box is located at a courier using a target terminal. The target terminal may be any terminal pre-designated based on actual application requirements. The target terminal may alternatively be determined according to a rule, for example, may be a terminal used by a courier responsible for a delivery of items in an area to which a position indicated by the target address information belongs. The usage status matching condition may include that usage status information is information representing that a delivery box is not occupied.

Alternatively, the usage status matching condition may further include that within a preset time period, usage status information of a delivery box indicates that the delivery box is in a usage status of not being occupied.

In some alternative implementations of this embodiment, in response to receiving item delivery information send by a target delivery terminal, the execution body may further determine a piece of delivery box information corresponding to the item delivery information in the preset set of pieces of delivery box information as the matching piece of delivery box information. The target delivery terminal may be any terminal pre-designated based on actual application requirements. The target terminal may alternatively be determined according to a rule, for example, may be a terminal used by a courier responsible for a delivery of items in an area to which a position indicated by the target address information belongs. As another example, in a scenario of sending an item, the target delivery terminal may alternatively be a terminal used by a user. The delivery information of the item may be used to represent that the item is sent by using a delivery box indicated by second identification information of the delivery box in the item delivery information.

The item delivery information may include the second identification information of the delivery box. The item delivery information may be used to represent that the item is delivered through a delivery box indicated by the second identification information.

It should be noted that the second identification information may be the same as or different from the first identification information. If the second identification information is the same as the first identification information, the description of the first identification information is also applicable to the second identification information. As an example, in practice, the first identification information may be displayed on a body of the delivery box. In this case, a user may identify a matching delivery box based on the second identification information of the delivery box in the item delivery information received by the target delivery terminal. If the second identification information is different from the first identification information, the second identification information may be used to distinguish different delivery boxes located at the position indicated by the target address information. As an example, the second identification information may be “Box 8 of No. 1 delivery box station on the east side of Building No. 3 of XX Community”. Correspondingly, a box number “8” may be displayed on the body of the delivery box.

Step 203 includes updating the usage status information in the matching piece of delivery box information to information representing that the delivery box is occupied.

In this embodiment, the execution body may update the usage status information in the matching piece of delivery box information determined in step 202 to the information representing that the delivery box is occupied.

In some alternative implementations of this embodiment, based on the alternative implementations of step 202, the execution body may alternatively acquire the position information of the delivery box indicated by the matching piece of delivery box information. Then, based on the acquired position information, the execution body may further update corresponding position information in the preset set of pieces of delivery box information. It should be appreciated that the corresponding position information may be the position information in the matching piece of delivery box information in the preset set of pieces of delivery box information.

Based on the alternative implementations, the execution body may further associatively store the first identification information in the matching piece of delivery box information and the item sending-receiving information.

In some alternative implementations of this embodiment, based on the associative storage of first identification information in the matching piece of delivery box information and the item sending-receiving information, the information representing that the delivery box is occupied may include information representing that the item is to be collected. The item sending-receiving information may further includes information of an item receiving terminal. The information of the item receiving terminal may be used to indicate a terminal used by a user receiving the item. As an example, in a scenario of sending an item, the information of the item receiving terminal may be used to indicate a terminal used by a courier receiving an item to be sent. As another example, in a scenario of receiving an item, the information of the item receiving terminal may be used to indicate a terminal used by a user receiving an item to be received.

Based on the alternative implementation, in response to receiving information sent by the target delivery terminal, which represents that the usage status information in the matching piece of delivery box information is updated to the information representing that the item is to be collected, the execution body may send item collecting information to the item receiving terminal indicated by the item sending-receiving information associated with the matching piece of delivery box information, where the item collecting information may include the second identification information in the matching piece of delivery box information.

In some alternative implementations of this embodiment, after the item collecting information is sent to the item receiving terminal indicated by the item sending-receiving information associated with the matching piece of delivery box information, the execution body may continue to perform the following steps.

A first Step includes recording a sending time of the item collecting information.

A second step includes performing, in response to receiving an item collecting request sent by the item receiving terminal, information verification on the item receiving terminal.

In these implementations, the item collecting request may include verification information of the item collection. The verification information of the item collection may include various forms, such as a verification code, an identity verification information (such as a user name and a password). Therefore, the execution body may perform the information verification by determining whether the verification information in the item collecting request sent by the item receiving terminal matches preset verification information.

A third step includes sending, in response to determining that the information verification is passed, information representing opening the box to the delivery box indicated by the matching piece of delivery box information.

Alternatively, in response to determining that the information verification is passed, based on the sending time and a time of receiving the item collecting request, the execution may further send information of requesting a payment of a bill to the item receiving terminal. Then, in response to determining that the payment of the bill is completed, the execution body may send the information representing opening the box to the delivery box indicated by the matching piece of delivery box information.

A fourth step includes updating the usage status information in the matching piece of delivery box information and the item sending-receiving information associated with the matching piece of delivery box information.

In these implementations, the execution body may first update the usage status information in the matching piece of delivery box information. The updated usage status information may be, for example, information representing idleness. Then, the execution body may determine the item sending-receiving information associated with the identification information in the matching piece of delivery box information, and then update the determined item sending-receiving information. The item sending-receiving information may further include logistics status indicating information representing whether a receipt of the item is signed.

In some alternative implementations of this embodiment, based on the alternative implementation of step 202, in response to receiving a change request of the delivery box information sent by the target delivery terminal, the execution body may update the usage status information in the delivery box information indicated by the change request of the delivery box information to information representing that usage is completed, where the change request of the delivery box information may include the first identification information of the delivery box.

In some alternative implementations of this embodiment, after the usage status information in the delivery box information indicated by the change request of the delivery box information is updated to the information representing that usage is completed, the execution body may determine the delivery box indicated by the change request of the delivery box information as a target delivery box. Then, the execution body may acquire position information of the target delivery box, and then update, based on the position information of the target delivery box, corresponding position information in the preset set of pieces of delivery box information. Therefore, the delivery box information in the preset set of pieces of delivery box information may reflect a real-time status of the delivery box. Further, an information basis may be provided for determining the matching delivery box.

In some alternative implementations of this embodiment, the execution body may update, based on usage status information and position information in the delivery box information in the preset set of pieces of delivery box information, usage status information in the target number of pieces of delivery box information to information representing that a delivery box is to be recycled.

In these implementations, the execution body may update, in various ways based on pieces of the usage status information and pieces of the position information in the pieces of the delivery box information in the preset set of pieces of delivery box information, pieces of the usage status information in the target number of pieces of the delivery box information to pieces of information representing that the delivery box is to be recycled. As an example, the execution body may update, based on a preset keeping number of a position indicated by each piece of position information, pieces of usage status information in pieces of delivery box information corresponding to delivery boxes beyond the preset keeping number among delivery boxes near the position, to information representing that the delivery boxes are to be recycled.

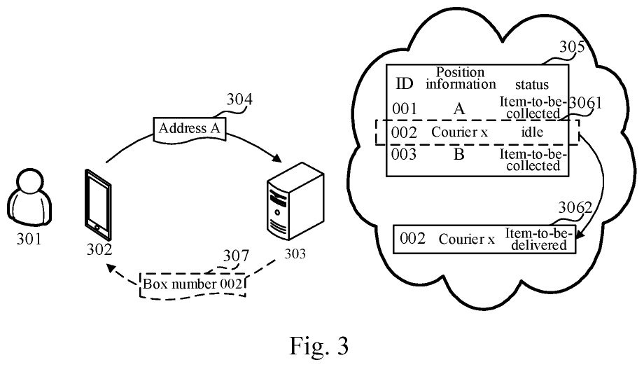

Further referring to FIG. 3, FIG. 3 is a schematic diagram of an application scenario of an embodiment of the method for sharing a delivery box according to the present disclosure. In the application scenario of FIG. 3, a user (not shown in FIG. 3) chooses to delivery an item by using a delivery box. The receiving address is “Address A”. The courier 301 sends the item sending-receiving information 304 indicating delivering using a delivery box to the server 303 by using the terminal device 302. The item sending-receiving information 304 includes the target address information “Address A”. The server 303 determines a matching piece of delivery box information 3061 matching the item sending-receiving information 304 from the preset set of pieces of delivery box information 305. The courier x301 may place the item to be delivered in the delivery box with ID 002. Then, the server 303 updates the usage status information in the matching piece of delivery box information 3061 to “item-to-be-delivered” 3062. Alternatively, the server 303 may further send the information 307 including the first identification information “002” in the matching piece of delivery box information to the terminal device 302.

Currently, one of the existing technologies is generally to find a preset logistics station manually. However, the volume and occupied space of the preset logistics station is fixed after being put into use, so that the station cannot be expanded and recycled based on the occupancy, and the utilization rate is not high. According to the method provided in the embodiments of the present disclosure, by determining the matching piece of delivery box information from the preset set of pieces of delivery box information and updating the usage status information in the matching piece of delivery box information, the deployment of the existing boxes is realized according to the position and the usage status. Moreover, the flexible adjustment of the number of delivery boxes in different areas is also realized by performing the information interaction with the terminal, thereby improving the efficiency of the logistics.

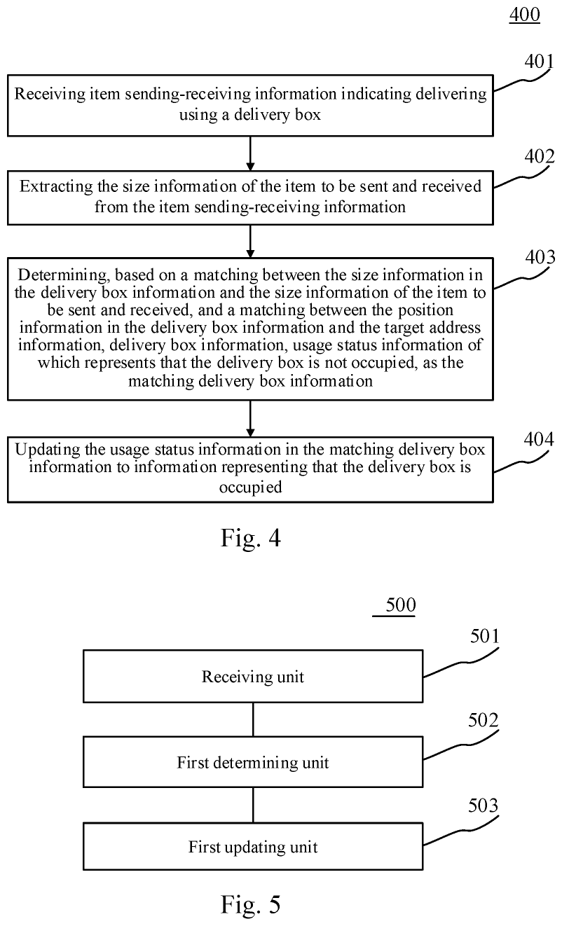

Further referring to FIG. 4, FIG. 4 is a flow 400 of another embodiment of the method for sharing a delivery box. The flow 400 of the method for sharing a delivery box includes steps 401 to 404.

Step 401 includes receiving item sending-receiving information indicating delivering using a delivery box.

In this embodiment, the item sending-receiving information may further include size information of an item to be sent and received. The delivery box information may further include size information of the delivery box.

Step 402 includes extracting the size information of the item to be sent and received from the item sending-receiving information.

In this embodiment, the execution body of the method for sharing a delivery box may extract the size information of the item to be sent and received from the item sending-receiving information received in step 401.

Step 403 includes determining, based on a matching between the size information in the delivery box information and the size information of the item to be sent and received, and a matching between the position information in the delivery box information and the target address information, delivery box information including usage status information representing that the delivery box is not occupied, as the matching piece of delivery box information.

In this embodiment, the execution body may determine the matching piece of delivery box information from the preset set of pieces of delivery box information. As an example, the execution body may select, from the preset set of pieces of delivery box information, a piece of delivery box information whose size information indicates a size greater than a size indicated the size information of the item to be sent and received, as candidate matching pieces of delivery box information. Then, the execution body may select, from the candidate matching pieces of delivery box information, a candidate matching piece of delivery box information whose position information indicates a position closest to an address indicated by the target address information, as the matching piece of delivery box information.

Step 404 includes updating the usage status information in the matching piece of delivery box information to information representing that the delivery box is occupied.

Step 401 and step 404 are respectively consistent with step 201 and step 203 in the previous embodiment, respectively. The descriptions of step 201 and step 203 are also applicable to step 401 and step 404, and details are not described herein.

In some alternative implementations of this embodiment, the execution body may further record a start time of updating the usage status information in the matching piece of delivery box information to the information representing that the delivery box is occupied; and then update, in response to determining that the delivery box indicated by the matching piece of delivery box information is not opened during a period from the start time to a target time, the usage status information in the matching piece of delivery box information to information representing that the delivery box is not occupied. The target time may be determined in various ways. As an example, the target time may be included in the received item sending-receiving information. As another example, the target time may alternatively be a time determined by a preset time period (such as one hour) after the start time.

In some alternative implementations of this embodiment, the execution body may update, based on usage status information and position information in the delivery box information in the preset set of pieces of delivery box information, usage status information in the target number of pieces of delivery box information to information representing that a delivery box is to be recycled.

The alternative implementations are consistent with the descriptions of the corresponding steps in the previous embodiment, and details are not described herein.

As can be seen from FIG. 4, the flow 400 of the method for sharing a delivery box in this embodiment embodies the step of determining the matching piece of delivery box information based on the size information and the position information. Thus, the solution described in this embodiment can determine the matching piece of delivery box information from the preset set of pieces of delivery box information by the execution body. Compared with determining the matching piece of delivery box information through the information sent by the terminal, the network transmission resources can be saved. By actively determining the matching delivery box through the execution body, the usage efficiency of the delivery box can be improved.

Further referring to FIG. 5, as an implementation of the method shown in above figures, the present disclosure provides an embodiment of an apparatus for sharing a delivery box. The embodiment of the apparatus corresponds to the embodiment of the method shown in FIG. 2, and the apparatus is particularly applicable to various electronic devices.

As shown in FIG. 5, the apparatus 500 for sharing a delivery box provided by this embodiment includes: a receiving unit 501, a first determining unit 502 and a first updating unit 503. The receiving unit 501 is configured to receive item sending-receiving information indicating delivering using a delivery box, where the item sending-receiving information includes target address information, and the target address information is used to indicate a start fixed position of using the delivery box to carry the item; the first determining unit 502 is configured to determine a matching piece of delivery box information from a preset set of pieces of delivery box information, where position information and usage status information in the matching piece of delivery box information meet a preset matching condition, the matching piece of delivery box information includes: the position information, first identification information and the usage status information, and the usage status information is used to represent whether the delivery box indicated by the corresponding first identification information is occupied; and the first updating unit 503 is configured to update the usage status information in the matching piece of delivery box information to information representing that the delivery box is occupied.

In this embodiment, in the apparatus 500 for sharing a delivery box, the specific processing of the receiving unit 501, the first determining unit 502 and the first updating unit 503 and the technical effects thereof may be described with reference to step 201, step 202 and step 203 in the embodiment corresponding to FIG. 2 respectively, and details are not described herein.

In some alternative implementations of this embodiment, the first determining unit 501 is further configured to: determine, in response to receiving item delivery information sent by a target delivery terminal, delivery box information corresponding to the item delivery information in the preset set of pieces of delivery box information as the matching piece of delivery box information, where the item delivery information includes second identification information of the delivery box, and is used to represent that the item is delivered through the delivery box indicated by the second identification information.

In some alternative implementations of this embodiment, the apparatus 500 for sharing a delivery box may further include: a first acquiring unit (not shown) and a second updating unit (not shown). The first acquiring unit is configured to acquire the position information of the delivery box indicated by the matching piece of delivery box information; and the second updating unit is configured to update, based on the acquired position information, corresponding position information in the preset set of pieces of delivery box information.

In some alternative implementations of this embodiment, the apparatus 500 for sharing a delivery box may further include: a storage unit (not shown), configured to associatively store the first identification information in the matching piece of delivery box information and the item sending-receiving information.

In some alternative implementations of this embodiment, the information representing that the delivery box is occupied may include information representing that the item is to be collected, and the item sending-receiving information may further include information of an item receiving terminal; and the apparatus 500 for sharing a delivery box may further include: a first sending unit (not shown), configured to send, in response to receiving information sent by a target delivery terminal and representing that the usage status information in the matching piece of delivery box information is updated to the information representing that the item is to be collected, item collecting information to the item receiving terminal indicated by the item sending-receiving information associated with the matching piece of delivery box information, where the item collecting information includes the second identification information in the matching piece of delivery box information.

In some alternative implementations of this embodiment, the apparatus 500 for sharing a delivery box may further include: a first recording unit (not shown), a verification unit (not shown), a second sending unit (not shown) and a third updating unit (not shown). The first recording unit is configured to record a sending time of the item collecting information; the verification unit is configured to perform, in response to receiving an item collecting request sent by the item receiving terminal, information verification on the item receiving terminal, where the item collecting request includes verification information of the item collection; the second sending unit is configured to send, in response to determining that the information verification is passed, information representing opening the box to the delivery box indicated by the matching piece of delivery box information; and the third updating unit is configured to update the usage status information in the matching piece of delivery box information and the item sending-receiving information associated with the matching piece of delivery box information.

In some alternative implementations of this embodiment, the second sending unit may include: a first sending module (not shown) and a second sending module (not shown). The first sending module is configured to send, based on the sending time and a time of receiving the item collecting request, information of requesting a payment of a bill to the item receiving terminal; and the second sending module is configured to send, in response to determining that the payment of the bill is completed, the information representing opening the box to the delivery box indicated by the matching piece of delivery box information.

In some alternative implementations of this embodiment, the apparatus 500 for sharing a delivery box may further include: a fourth updating unit (not shown), configured to update, in response to receiving a change request of the delivery box information sent by the target delivery terminal, the usage status information in the delivery box information indicated by the change request of the delivery box information to information representing that usage is completed, where the change request of the delivery box information includes the first identification information of the delivery box.

In some alternative implementations of this embodiment, the apparatus 500 for sharing a delivery box may further include: a second determining unit (not shown), a second acquiring unit (not shown) and a fifth updating unit (not shown). The second determining unit is configured to determine the delivery box indicated by the change request of the delivery box information as a target delivery box; the second acquiring unit is configured to acquire position information of the target delivery box; and the fifth updating unit is configured to update, based on the position information of the target delivery box, corresponding position information in the preset set of pieces of delivery box information.

In some alternative implementations of this embodiment, the item sending-receiving information may further include size information of an item to be sent and received, and the delivery box information may further include size information of the delivery box; and the first determining unit may include: an extracting module (not shown) and a determining module (not shown). The extracting module is configured to extract the size information of the item to be sent and received from the item sending-receiving information; and the determining module is configured to determine, based on a matching between the size information in the delivery box information and the size information of the item to be sent and received, and a matching between the position information in the delivery box information and the target address information, delivery box information with usage status information representing that the delivery box is not occupied, as the matching piece of delivery box information.

In some alternative implementations of this embodiment, the apparatus 500 for sharing a delivery box may further include: a second recording unit (not shown) and a sixth updating unit (not shown). The second recording unit is configured to record a start time of updating the usage status information in the matching piece of delivery box information to the information representing that the delivery box is occupied; and the sixth updating unit is configured to update, in response to determining that the delivery box indicated by the matching piece of delivery box information is not opened during a period from the start time to a target time, the usage status information in the matching piece of delivery box information to information representing that the delivery box is not occupied.

In some alternative implementations of this embodiment, the apparatus 500 for sharing a delivery box may further include: a seventh updating unit (not shown), configured to update, based on usage status information and position information in the delivery box information in the preset set of pieces of delivery box information, usage status information in a target number of pieces delivery box information to information representing that a delivery box is to be recycled.

According to the apparatus provided by the embodiments of the present disclosure, the item sending-receiving information indicating delivering using the delivery box is first acquired through the receiving unit 501, where the item sending-receiving information includes the target address information, and the target address information is used to indicate the start fixed position of using the delivery box to carry the item; then, the first determining unit 502 determines the matching piece of delivery box information from the preset set of pieces of delivery box information, where the position information and the usage status information in the matching piece of delivery box information meet the preset matching condition, and the matching piece of delivery box information includes the position information, the first identification information and the usage status information, and the usage status information is used to represent whether the delivery box indicated by the corresponding first identification information is occupied; and finally, the first updating unit 503 updates the usage status information in the matching piece of delivery box information to the information representing that the delivery box is occupied. Thus, the deployment of the existing boxes is realized according to the positions and the usage statuses.

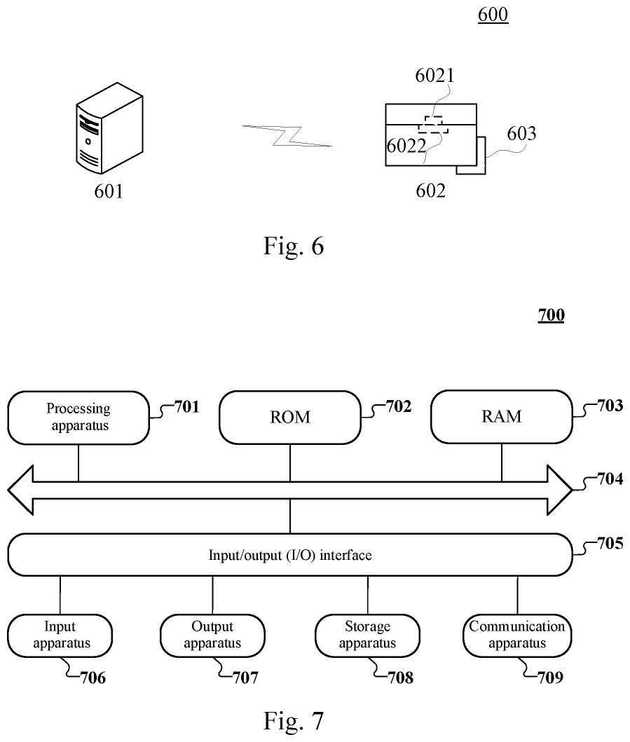

Further referring to FIG. 6, FIG. 6 shows a schematic structural diagram of an embodiment of a sharing system 600 of a smart delivery box according to the present disclosure.

As shown in FIG. 6, the sharing system 600 of the smart delivery box may include a server 601, a smart delivery box 602 and a fixed apparatus 603. In this embodiment, the server 601 may be configured to implement the method as described in any of the previous embodiments. The smart delivery box 602 may include a communication component 6021 and a smart lock 6022, where the smart lock 6022 may be controlled to be unlocked by the communication component 6021. The fixed apparatus 603 may have a detachable connection with the smart delivery box 602 through a lock body. The fixed apparatus 603 may be installed at a preset delivery position. Alternatively, the smart delivery box 602 may include a positioning apparatus (not shown).

According to the sharing system 600 of the smart delivery box provided by the embodiments of the present disclosure, the server 601 first receives item sending-receiving information indicating delivering using a delivery box. Then, the server 601 determines a matching piece of delivery box information from a preset set of pieces of delivery box information. Finally, the server 601 updates the usage status information in the matching piece of delivery box information to information representing that the delivery box is occupied. The smart delivery box 602 may be connected to the fixed apparatus 603 installed at the preset delivery position. The smart delivery box 602 may communicate with the server 601 through the communication component to receive or send messages. The smart delivery box 602 may further control the unlocking of the smart lock 6022 through the communication component 6021. Alternatively, the smart delivery box 602 may further send position information to the server 601 through the positioning apparatus. Thus, the flexible usage of the smart delivery box is realized, thereby improving the efficiency of the logistics.

Referring to FIG. 7, FIG. 7 shows a schematic structural diagram of an electronic device 700 (such as the server in FIG. 1) adapted to implement some embodiments of the present disclosure. The server shown in FIG. 7 is merely an example and should not be construed as limiting the functionality and use scope of the embodiments of the present disclosure.

As shown in FIG. 7, the electronic device 700 may include a processing apparatus 701 (such as a central processing unit and a graphic processor), which may execute various appropriate actions and processes in accordance with a program stored in a read-only memory (ROM) 702 or a program loaded into a random access memory (RAM) 703 from a storage apparatus 708. The RAM 703 also stores various programs and data required by operations of the electronic device 700. The processing apparatus 701, the ROM 702 and the RAM 703 are connected to each other through a bus 704. An input/output (I/O) interface 705 is also connected to the bus 704.

Generally, the following apparatuses may be connected to the I/O interface 705: an input apparatus 706 including a keyboard, a mouse, a camera and the like; an output apparatus 707 including a liquid crystal display (LCD), a speaker, a vibrator and the like; a storage apparatus 708 including a magnetic tap, a hard disk and the like; and a communication apparatus 709. The communication apparatus 709 may allow the electronic device 700 to perform wireless or wired communication with other devices to exchange data. Although FIG. 7 shows the electronic device 700 having various apparatuses, it should be appreciated that it is not required to implement or provide all the shown apparatuses, and it may alternatively be implemented or provided with more or fewer apparatuses. Each block shown in FIG. 7 may represent one apparatus or multiple apparatuses according to requirements.

In particular, according to embodiments of the present disclosure, the process described above with reference to the flowchart may be implemented as a computer software program. For example, embodiments of the present disclosure include a computer program product, which includes a computer program carried on a computer readable medium. The computer program includes program codes for executing the method shown in the flowchart. In such an embodiment, the computer program may be downloaded and installed from a network via the communication apparatus 709, or may be installed from the storage apparatus 708, or may be installed from the ROM 702. The computer program, when executed by the processing apparatus 701, implements the above functionalities as defined by the method of embodiments of the present disclosure.

It should be noted that the computer readable medium described by embodiments of the present disclosure may be computer readable signal medium or computer readable storage medium or any combination of the above two. The computer readable storage medium may be, but is not limited to: an electric, magnetic, optical, electromagnetic, infrared, or semiconductor system, an apparatus, a device, or any combination of the above. A more specific example of the computer readable storage medium may include but is not limited to: an electrical connection with one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In embodiments of the present disclosure, the computer readable storage medium may be any physical medium containing or storing programs which can be used by or in combination with an instruction execution system, an apparatus or device. In embodiments of the present disclosure, the computer readable signal medium may include a data signal in the base band or propagating as a part of a carrier, in which computer readable program codes are carried. The propagating signal may be various forms, including but not limited to: an electromagnetic signal, an optical signal or any suitable combination of the above. The computer readable signal medium may be any computer readable medium except for the computer readable storage medium. The computer readable signal medium is capable of transmitting, propagating or transferring programs for use by or in combination with an instruction execution system, an apparatus or a device. The program codes contained on the computer readable medium may be transmitted with any suitable medium including but not limited to: a wire, an optical cable, RF (Radio Frequency), or any suitable combination of the above.

The above computer readable medium may be included in the server; or may alternatively be present alone and not assembled into the server. The computer readable medium carries one or more programs that, when executed by the server, cause the server to: receive item sending-receiving information indicating delivering using a delivery box, where the item sending-receiving information includes target address information, and the target address information is used to indicate a start fixed position of using the delivery box to carry the item; determine a matching piece of delivery box information from a preset set of pieces of delivery box information, where position information and usage status information in the matching piece of delivery box information meet a preset matching condition, the matching piece of delivery box information includes the position information, first identification information and the usage status information, and the usage status information is used to represent whether the delivery box indicated by the corresponding first identification information is occupied; and update the usage status information in the matching piece of delivery box information to information representing that the delivery box is occupied.

A computer program code for executing operations of embodiments of the present disclosure may be written in one or more programming languages or a combination thereof. The programming languages include object-oriented programming languages, such as Java, Smalltalk or C++, and also include conventional procedural programming languages, such as “C” language or similar programming languages. The program code may be completely executed on a user computer, partially executed on a user computer, executed as a separate software package, partially executed on a user computer and partially executed on a remote computer, or completely executed on a remote computer or server. In a case involving a remote computer, the remote computer may be connected to a user computer through any kind of network, including a local area network (LAN) or a wide area network (WAN), or may be connected to an external computer (for example, connected through Internet using an Internet service provider).

The flowcharts and block diagrams in the accompanying drawings show architectures, functions and operations that may be implemented according to the systems, methods and computer program products of the various embodiments of the present disclosure. In this regard, each of the blocks in the flowcharts or block diagrams may represent a module, a program segment, or a code portion, the module, program segment, or code portion including one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flowcharts as well as a combination of blocks in the block diagrams and/or flowcharts may be implemented using a dedicated hardware-based system executing specified functions or operations, or by a combination of a dedicated hardware and computer instructions.

The units involved in some embodiments of the present disclosure may be implemented by means of software or hardware. The described units may also be provided in a processor, for example, described as: a processor, including a receiving unit, a first determining unit and a first updating unit, where the names of these units do not constitute a limitation to such units themselves in some cases. For example, the receiving unit may alternatively be described as “a unit of receiving item sending-receiving information indicating delivering using a delivery box, where the item sending-receiving information includes target address information, and the target address information is used to indicate a start fixed position of using the delivery box to carry the item”.

The above description only provides an explanation of the preferred embodiments of the present disclosure and the technical principles used. It should be appreciated by those skilled in the art that the inventive scope involved in the present disclosure is not limited to the technical solutions formed by the particular combinations of the above technical features. The inventive scope should also cover other technical solutions formed by any combinations of the above technical features or equivalent features thereof without departing from the concept of the present disclosure, such as technical solutions formed through the above features and technical features having similar functions provided (or not provided) in the present disclosure being replaced with each other.

1. A method for sharing a delivery box, the method comprising:
receiving item sending-receiving information indicating delivering using the delivery box, wherein the item sending-receiving information comprises target address information, and the target address information is used to indicate a start fixed position of using the delivery box to carry an item;
determining a matching piece of delivery box information from a preset set of pieces of delivery box information, wherein the matching piece of delivery box information comprises: position information, first identification information and usage status information, the position information and the usage status information meet a preset matching condition, and the usage status information is used to represent whether the delivery box indicated by the corresponding first identification information is occupied; and
updating the usage status information in the matching piece of delivery box information to information representing that the delivery box is occupied,
wherein the method is performed by a processor.

2. The method according to claim 1, wherein determining the matching piece of delivery box information from the preset set of pieces of delivery box information comprises:
determining, in response to receiving item delivery information sent by a target delivery terminal, a piece of delivery box information corresponding to the item delivery information in the preset set of pieces of delivery box information as the matching piece of delivery box information, wherein the item delivery information comprises a second identification information of the delivery box, and is used to represent that the item is delivered through the delivery box indicated by the second identification information.

3. The method according to claim 2, wherein the method further comprises:
acquiring the position information of the delivery box indicated by the matching piece of delivery box information; and
updating, based on the acquired position information, corresponding position information in the preset set of pieces of delivery box information.

4. The method according to claim 3, wherein the method further comprises:
storing associatively the first identification information in the matching piece of delivery box information and the item sending-receiving information.

5. The method according to claim 4, wherein the information representing that the delivery box is occupied comprises information representing that the item is to be collected, and the item sending-receiving information further comprises information of an item receiving terminal; and
the method further comprises:
sending, in response to receiving information sent by the target delivery terminal and representing that the usage status information in the matching piece of delivery box information is updated to the information representing that the item is to be collected, item collecting information to the item receiving terminal indicated by the item sending-receiving information associated with the matching piece of delivery box information, wherein the item collecting information comprises the second identification information in the matching piece of delivery box information.

6. The method according to claim 5, wherein the method further comprises:
recording a sending time of the item collecting information;
performing, in response to receiving an item collecting request sent by the item receiving terminal, information verification on the item receiving terminal, wherein the item collecting request comprises verification information of item collection;
sending, in response to determining that the information verification is passed, information representing opening the box to the delivery box indicated by the matching piece of delivery box information; and
updating the usage status information in the matching piece of delivery box information and the item sending-receiving information associated with the matching piece of delivery box information.

7. The method according to claim 6, wherein sending the information representing opening the box to the delivery box indicated by the matching piece of delivery box information comprises:
sending, based on the sending time and a time of receiving the item collecting request, information of requesting a payment of a bill to the item receiving terminal; and
sending, in response to determining that the payment of the bill is completed, the information representing opening the box to the delivery box indicated by the matching piece of delivery box information.

8. The method according to claim 2, wherein the method further comprises:
updating, in response to receiving a change request of the delivery box information sent by the target delivery terminal, the usage status information in the delivery box information indicated by the change request of the delivery box information to information representing that usage is completed, wherein the change request of the delivery box information comprises the first identification information of the delivery box.

9. The method according to claim 8, wherein the method further comprises:
determining the delivery box indicated by the change request of the delivery box information as a target delivery box;
acquiring position information of the target delivery box; and
updating, based on the position information of the target delivery box, corresponding position information in the preset set of pieces of delivery box information.

10. The method according to claim 1, wherein the item sending-receiving information further comprises size information of the item to be sent and received, and the delivery box information further comprises size information of the delivery box; and determining the matching piece of delivery box information from the preset set of pieces of delivery box information comprises:
extracting the size information of the item to be sent and received from the item sending-receiving information; and
determining, based on a matching between the size information in the delivery box information and the size information of the item to be sent and received, and a matching between the position information in the delivery box information and the target address information, delivery box information with usage status information representing that the delivery box is not occupied as the matching piece of delivery box information.

11. The method according to claim 10, wherein the method further comprises:
recording a start time of updating the usage status information in the matching piece of delivery box information to the information representing that the delivery box is occupied; and
updating, in response to determining that the delivery box indicated by the matching piece of delivery box information is not opened during a period from the start time to a target time, the usage status information in the matching piece of delivery box information to information representing that the delivery box is not occupied.

12. The method according to claim 1, wherein the method further comprises:
updating, based on usage status information and position information in the pieces of the delivery box information in the preset set of pieces of delivery box information, usage status information in a target number of pieces of delivery box information to information representing that the delivery box is to be recycled.

13. An apparatus for sharing a delivery box, the apparatus comprising:
at least one processor; and
a memory storing instructions executable by the at least one processor, wherein the instructions, when executed by the at least one processor, cause the at least one processor to perform operations comprising:
receiving item sending-receiving information indicating delivering using the delivery box, wherein the item sending-receiving information comprises target address information, and the target address information is used to indicate a start fixed position of using the delivery box to carry the item;
determining a matching piece of delivery box information from a preset set of pieces of delivery box information, wherein the matching piece of delivery box information comprises: position information, first identification information and usage status information, the position information and the usage status information meet a preset matching condition, and the usage status information is used to represent whether the delivery box indicated by the corresponding first identification information is occupied; and
updating the usage status information in the matching piece of delivery box information to information representing that the delivery box is occupied.

14. A sharing system of a smart delivery box, the system comprising:
the smart delivery box, comprising a communication component and a smart lock, wherein the communication component is configured to control the smart lock to be unlocked;
a fixed apparatus installed at a preset delivery position, configured to be detachably connected to the smart lock through a lock body; and
a server, wherein the server comprises at least one processor, and a memory storing instructions executable by the at least one processor, wherein the instructions, when executed by the at least one processor, cause the at least one processor to perform operations comprising:
receiving item sending-receiving information indicating delivering using the delivery box, wherein the item sending-receiving information comprises target address information, and the target address information is used to indicate a start fixed position of using the delivery box to carry an item;
determining a matching piece of delivery box information from a preset set of pieces of delivery box information, wherein the matching piece of delivery box information comprises: position information, first identification information and usage status information, the position information and the usage status information meet a preset matching condition, and the usage status information is used to represent whether the delivery box indicated by the corresponding first identification information is occupied; and
updating the usage status information in the matching piece of delivery box information to information representing that the delivery box is occupied.

15. (canceled)

16. A non-transitory computer-readable medium storing a computer program, wherein the program, when executed by a processor, implements the method according to claim 1.
